(19) United States
(12) Patent Application Publication
(10) Pub. No.: US 2006/0023615 A1
(43) Pub. Date: Feb. 2, 2006

(54) Optical disk and information playback apparatus

(76) Inventor: Yasuaki Ootera, Kawasaki-shi (JP)

Correspondence Address: OBLON, SPIVAK, MCCLELLAND, MAIER & NEUSTADT, P.C., 1940 DUKE STREET, ALEXANDRIA, VA, 22314, US

(21) Appl. No.: 11/179,561

(22) Filed: Jul. 13, 2005

(30) Foreign Application Priority Data
Jul. 28, 2004 (JP) 2004-220742

(51) Int. Cl. G11B 7/24

(52) U.S. Cl. 369/272.1; 369/275.1; 369/283

(57) ABSTRACT

An optical disk according to an example of the present invention includes the first and second recording layers on which pieces of information can be recorded by undergoing a change in properties when irradiated with a laser beam. The first recording layer has the first reflectance characteristic in which the reflectance in an information recorded state is lower than that in an information unrecorded state. The second recording layer has the second reflectance characteristic in which the reflectance in the information recorded state is higher than that in the information unrecorded state.

### CROSS-REFERENCE TO RELATED APPLICATIONS

This application is based upon and claims the benefit of priority from prior Japanese Patent Application No. 2004-220742, filed Jul. 28, 2004, the entire contents of which are incorporated herein by reference.

### BACKGROUND OF THE INVENTION

1. Field of the Invention

The present invention relates to, e.g., a WORM optical disk. The present invention also relates to an information playback apparatus which plays back information recorded on such a WORM optical disk.

2. Description of the Related Art

In recent years, various optical disks have been introduced, and the research and development of the various optical disks have been enthusiastically conducted. For example, in Jpn. Pat. Appln. KOKAI Publication No. 2003-051137, the optical disk having a plurality of recording layers is disclosed. In this reference, a technique of equalizing the signal strengths of the layers to obtain stable signal characteristics in any layers by adjusting the transmittances of the recording layers is described.

However, in the optical disk having the plurality of recording layers, if the layers have an equal signal strength in a disk structure, a signal leakage from another layer becomes a noise source in recording information. Accordingly, the preferable signal characteristics cannot be obtained, thus posing a problem.

### BRIEF SUMMARY OF THE INVENTION

According to an aspect of the present invention, there is provided an optical disk including a first surface and a second surface, comprising a first recording layer which is arranged between the first surface and the second surface, and on which information is configured to be recorded by a laser beam from the first surface, and a second recording layer which is arranged between the first surface and the second surface, and on which the information is configured to be recorded by the laser beam from the first surface, wherein the first recording layer has a first reflectance characteristic in which reflectance in an information recorded state is lower than reflectance in an information unrecorded state, and the second recording layer has a second reflectance characteristic in which the reflectance in the information recorded state is higher than the reflectance in the information unrecorded state.

According to another aspect of the present invention, there is provided an information playback apparatus which plays back information recorded on an optical disk including a first surface and a second surface, comprising an emitting unit configured to emit a light beam on the optical disk having a first recording layer which is arranged between the first surface and the second surface, and on which information is configured to be recorded by a laser beam from the first surface, and a second recording layer which is arranged between the first surface and the second surface, and on which the information is configured to be recorded by the laser beam from the first surface, wherein the first recording layer has a first reflectance characteristic in which reflectance in an information recorded state is lower than reflectance in an information unrecorded state, and the second recording layer has a second reflectance characteristic in which the reflectance in the information recorded state is higher than the reflectance in the information unrecorded state, a detection unit configured to detect reflected light from the optical disk, and a playback unit configured to play back the information recorded on the optical disk, on the basis of the reflected light detected by the detection unit.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate embodiments of the invention, and together with the general description given above and the detailed description of the embodiments given below, serve to explain the principles of the invention.

FIG. 1 is a sectional view of a single-sided/two-layered WORM optical disk according to an example of the present invention;

FIG. 2 is a view showing the flow of a manufacturing method of the single-sided/two-layered WORM optical disk according to the example of the present invention; and

FIG. 3 is a block diagram showing a schematic arrangement of an optical disk apparatus (information recording/playback apparatus) according to the example of the present invention.

### DETAILED DESCRIPTION OF THE INVENTION

An embodiment will be described below with reference to the accompanying drawing.

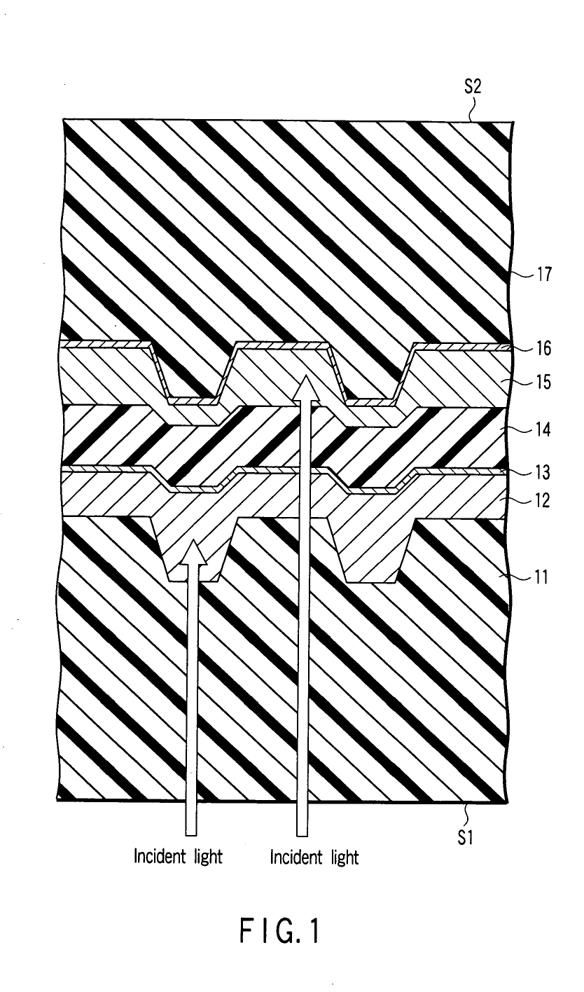

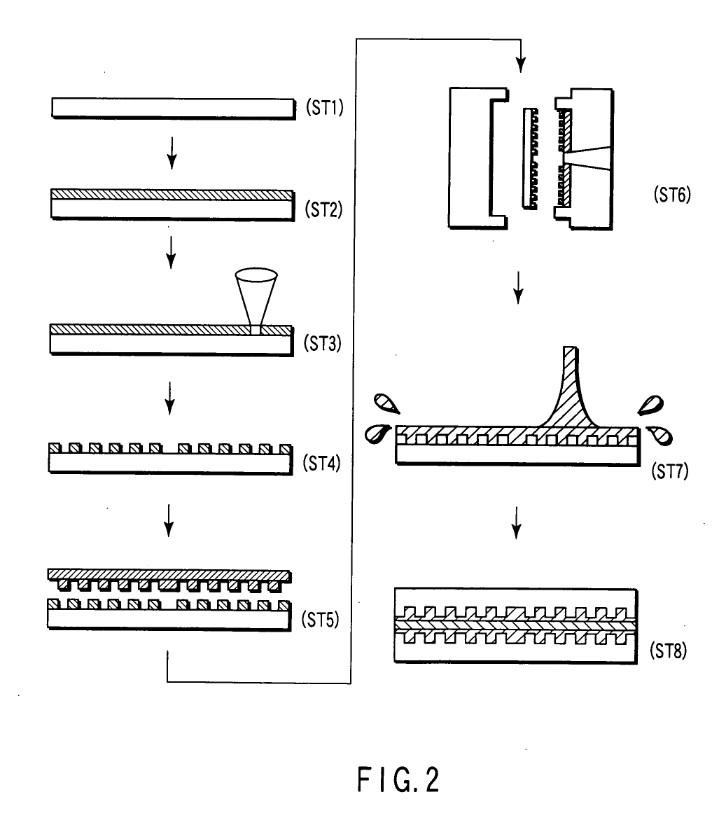

FIG. 1 is a sectional view of a single-sided/two-layered WORM optical disk according to an example of the present invention. FIG. 2 is a view showing the flow of a manufacturing method of the single-sided/two-layered WORM optical disk according to the example of the present invention.

As shown in FIG. 1, the single-sided/two-layered WORM optical disk includes a first surface S1 and a second surface S2. This two-layered WORM optical disk includes a molded substrate 11 which is positioned on a light beam incident surface side (first surface S1), and a molded substrate 17 which is positioned on the opposite side (second surface S2) to the light beam incident surface side. This two-layered WORM optical disk also includes a recording layer 12 which is arranged between the first and second surfaces S1 and S2 and can record the information by undergoing a change in properties when irradiated with a laser beam from the first surface S1, a reflecting layer 13 which is arranged between the recording layer 12 and the molded substrate 17, an adhesive layer 14 which is arranged between the reflecting layer 13 and the molded substrate 17, a recording layer 15 which is arranged between the adhesive layer 14 and the molded substrate 17 and can record the information by undergoing a change in properties when irradiated with the layer beam from the first surface S1, and a reflecting layer 16 which is arranged between the recording layer 15 and the molded substrate 17.

The molded substrate 11 on the light incident side has a tracking groove. This groove forms a so-called groove track. Accordingly, the groove tracks and land tracks are alternately arranged in the radial direction of the disk. The recording layer 12 is arranged in the groove of the molded substrate 11. This recording layer 12 is a layer using an organic dye which undergoes a change in properties when irradiated with light. A peripheral groove deforms by this change in properties to form a mark, and record the information. A diazo organic dye material, cyanine organic dye material, styryl organic dye material, or phthalocyanine organic dye material, or a mixture thereof is used in the recording layer 12. On the recording layer 12, for example, the reflecting layer 13 made of Al or Ag is formed by sputtering or the like. As described above, a first layer L0 is formed by adhering the molded substrate 11, recording layer 12, and reflecting layer 13.

Similarly, the molded substrate 17 on the opposite side to the light incident side also has a tracking groove. This groove forms a so-called groove track. Accordingly, the groove tracks and land tracks are alternately arranged in the radial direction of the disk. The recording layer 15 is arranged in the groove of the molded substrate 17 through the reflecting layer 16. This recording layer 15 is a layer using an organic dye which undergoes a change in properties when irradiated with light. A peripheral groove deforms by this change in properties to form a mark, and record the information. As described above, a second layer L1 is formed by adhering the molded substrate 17, reflecting layer 16, and recording layer 15. That is, the layers in each of the second and first layers L1 and L0 are arranged in the different orders.

One optical disk is formed by adhering the above first and second layers L0 and L1 through the adhesive layer 14.

In this embodiment, assume that a disk has a diameter of 120 mm and a thickness of 1.2 mm (adhering two layers including polycarbonate molded substrates each having a thickness of 0.6 mm), and this disk serves as the WORM optical disk. Of course, the disk of the present invention is not limited to these numerical values. For example, as recording/playback light applied to the disk in the first embodiment, recording/playback light having a wavelength of 400 nm is used. As an optical objective lens which processes this recording/playback light, a lens having an NA of 0.65 is used. Also, in the disk according to the first embodiment, a track pitch between the grooves becomes 400 nm. However, the disk of the present invention is not limited to these numerical values.

The manufacturing method of the above-described two-layered WORM optical disk will be described below with reference to FIG. 2. A master is made of glass, and has a surface which is polished and cleaned (ST1). A photoresist is applied to the surface of the master (ST2), and the photoresist surface is exposed to the laser beam and the like to record the information (ST3). Next, the exposed master is developed to form convex and concave portions such as the pits and groove (ST4). After that, the master is plated, and then a stamper (generally made of nickel) is formed (ST5). By using the stamper as a mold, the molded substrate 1 made of a resin (generally made of polycarbonate) is formed by injecting molding (ST6). The organic dye is applied by spin coating as the recording layer 12 on the above-described molded substrate 1 (ST7). The reflecting layer 13 is formed on the recording layer 12 of the organic dye. As described above, the first layer L0 is formed. Similarly, the molded substrate 17 is formed (ST6), the reflecting layer 16 is formed on this molded substrate 17, and the organic dye is applied by spin coating as the recording layer 15 on the reflecting layer 16 (ST7). Thus, the second layer L1 is formed. The first and second layers L0 and L1 are adhered through the adhesive layer 14. With this operation, the two-layered WORM optical disk is completely formed (ST8).

The recording principle of the WORM optical disk using the organic dye will be described below. For example, the recording laser beam having a wavelength of 400 nm is applied to the organic dye filled in the groove of the molded substrate. The refractive index of the organic dye which initiates a chemical reaction is changed, and the adjacent molded substrate is deformed by reaction heat of the organic dye to form a recording mark. This is the recording principle of the general WORM optical disk. In this case, in accordance with the refractive index and film thickness of the organic dye and the depth of the groove, a (H-L: High-to-Low) recording layer in which the reflectance changes from high to low before and after recording and a (L-H: Low-to-High) recording layer in which the reflectance changes from low to high before and after recording can be discriminatively formed. That is, the H-L recording layer (first recording layer) has the first reflectance characteristic in which the reflectance in an information recorded state is lower than that in an information unrecorded state. To the contrary, the L-H recording layer (second recording layer) has the second reflectance characteristic in which the reflectance in the information recorded state is higher than that in the information unrecorded state.

The dye composed of the recording layer of the Low-to-High medium has been proposed in Jpn. Pat. Appln. KOKAI Publication Nos. 2002-74740 and 2002-206061.

Alternatively, the recording layer may be made of an inorganic material in place of the organic dye. In this case, recording is performed by changing the phase from amorphous to crystalline and vice versa, by the heat of a recording laser beam. When using the inorganic material, the (H-L: High-to-Low) recording layer in which the reflectance changes from high to low before and after recording, and the (L-H: Low-to-High) recording layer in which the reflectance changes from low to high before and after recording can also be discriminatively formed.

In the single-sided/two-layered recording optical disk, when recording the information on one recording layer, the signal (noise) from the other recording layer causes a problem. The problem is a so-called interlayer crosstalk. This problem also occurs when the other recording layer is in the unrecorded state (no recording mark is formed). In this case, coherent light from the groove which is formed in the disk substrate in advance becomes a noise source.

Hence, in the single-sided/two-layered WORM optical disk according to the first embodiment of the present invention, the layer L0 is formed of the H-L recording layer (first recording layer), and the layer L1 is formed of the L-H recording layer (second recording layer). That is, the H-L recording layer (first recording layer) is arranged between the first surface S1 and the L-H recording layer (second recording layer). The H-L recording layer (first recording layer) is used to record the information before the L-H recording layer (second recording layer) is used, and the L-H recording layer (second recording layer) is used after the recording area of the H-L recording layer (first recording layer) is completely used.

In this arrangement, first, when recording the information on the layer L0, high initial reflectance and stable servo operation can be achieved. In addition to this, since the reflectance of the layer L1 in the unrecorded state is low, the interlayer crosstalk from the layer L1 is so small that it may be ignored. Hence, good recording characteristics can be obtained. When writing the information on the layer L1, the information has been written on the entire surface of the layer L0. Hence, the polarity causes no disadvantage. In this disk structure, the recording characteristics especially on the first layer are improved.

Furthermore, a prepit recorded upon manufacturing the disk is formed on the H-L recording layer (first recording layer) with high reflectance, in consideration of read precision. The prepit serves as control information and management information to indicate the pieces of information of the disk, disk manufacturer, copy protection, and polarity. Also, the prepit is formed in order to detect the tilt of the disk. The polarity information is information which indicates that the H-L recording layer (first recording layer) has the first reflectance characteristic, and the second recording layer has the second reflectance characteristic.

Alternatively, in the single-sided/two-layered WORM optical disk according to the second embodiment of the present invention, the layer L0 is formed of the L-H recording layer (second recording layer), and the layer L1 is formed of the H-L recording layer (first recording layer). That is, the L-H recording layer (second recording layer) is arranged between the first surface S1 and the H-L recording layer (first recording layer). Also, the H-L recording layer (first recording layer) is used to record the information before the L-H recording layer (second recording layer) is used, and the L-H recording layer (second recording layer) is used after the recording area of the H-L recording layer (first recording layer) is completely used.

In this arrangement, first, when recording the information on the layer L1, high initial reflectance and stable servo operation can be achieved. In addition to this, since the reflectance of the layer L0 in the unrecorded state is low, the interlayer crosstalk from the layer L0 is so small that it may be ignored. Hence, good recording characteristics can be obtained. When writing the information on the layer L0, the information has been written on the entire surface of the layer L1. Hence, the polarity causes no disadvantage. In this disk structure, the recording characteristics especially on the first layer are improved.

Furthermore, a prepit recorded upon manufacturing the disk is formed on the H-L recording layer (first recording layer) with high reflectance, in consideration of read precision. The prepit serves as control information and management information to indicate the pieces of information of the disk, disk manufacturer, copy protection, and polarity. Also, the prepit is formed in order to detect the tilt of the disk. The polarity information is information which indicates that the H-L recording layer (first recording layer) has the first reflectance characteristic, and the second recording layer has the second reflectance characteristic.

As described above, in the single-sided/two-layered WORM optical disk according to the present invention, the polarity of one recording layer (recording layer for recording the information first) is assumed to be H-L, and that of the other recording layer is assumed to be L-H. Hence, high initial reflectance and stable servo operation can be achieved on the recording layer on which the information is recorded first. In addition to this, since the reflectance of the other recording layer (before recording) is low, the interlayer crosstalk can be small. When recording the information on the other recording layer, since the information has been recorded on the entire recording area on one recording layer, the polarity of the other recording layer causes no disadvantage. Therefore, in this disk structure, the recording characteristics especially to the first layer are improved.

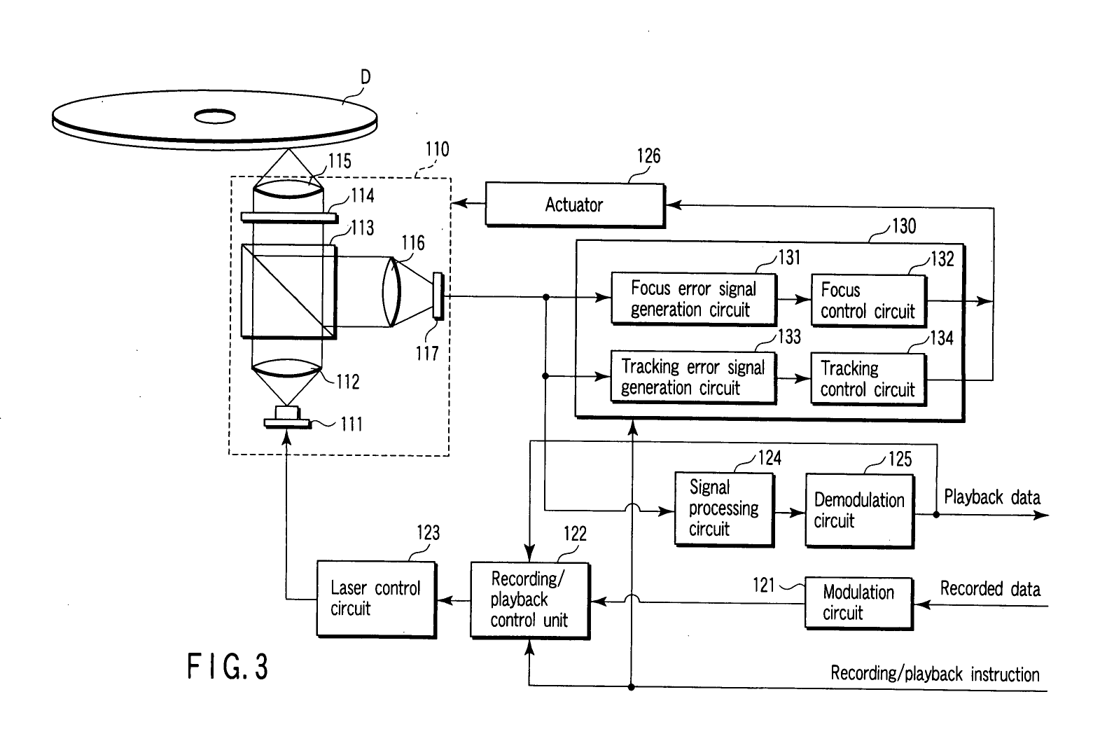

Referring to FIG. 3, an information recording/playback apparatus which causes the laser beam to apply to the above-described single-sided/two-layered WORM optical disk, records the information on these optical disks, and plays back the information recorded on the optical disks will be described below. FIG. 3 is a block diagram showing a schematic arrangement of the optical disk apparatus (information recording/playback apparatus) according to an example of the present invention.

As shown in FIG. 3, the optical disk apparatus includes an optical pickup 110, modulation circuit 121, recording/playback control unit 122, laser control circuit 123, signal processing circuit 124, demodulation circuit 125, actuator 126, and focus tracking control unit 130.

The optical pickup 110 also includes a laser 111, collimator lens 112, polarization beam splitter (to be referred to as a PBS hereinafter) 113, quarter wavelength plate 114, objective lens 115, focus lens 116, and photodetector 117.

The focus tracking control unit 130 also includes a focus error signal generation circuit 131, focus control circuit 132, tracking error signal generation circuit 133, and tracking control circuit 134.

The operation of recording the information on an optical disk D in this optical disk apparatus will be described below. The modulation circuit 121 modulates recorded information (data symbol) from a host in accordance with a predetermined modulation method into a channel bit sequence. The channel bit sequence corresponding to the recorded information is input to the recording/playback control unit 122. Also, a recording/playback instruction (in this case, recording instruction) is output from the host to this recording/playback control unit 122. The recording/playback control unit 122 outputs a control signal to the actuator 126, and drives an optical pickup such that the light beam is appropriately focused on a target recording position. The recording/playback control unit 122 also supplies the channel bit sequence to the laser control circuit 123. The laser control circuit 123 converts the channel bit sequence into a laser driving waveform, and drives the laser 111. That is, the laser control circuit 123 pulse-drives the laser 111. In accordance with this operation, the laser 111 emits the recording light beam corresponding to the desired bit sequence.

The recording light beam emitted from the laser 111 becomes parallel light by the collimator lens 112, and enters and passes through the PBS 113. The beam passing through the PBS 113 then passes through the quarter wavelength plate 114, and focused on the information recording surface of the optical disk D by the objective lens 115. The focused recording light beam is maintained in an optimal microspot on the recording surface (recording layer 12 or 15) by focus control performed by the focus control circuit 132 and actuator 126, and the tracking control performed by the tracking control circuit 134 and actuator 126.

The operation of playing back the data from the optical disk D in this optical disk apparatus will be described below. A recording/playback instruction (in this case, playback instruction) is output from the host to the recording/playback control unit 122. The recording/playback control unit 122 outputs a playback control signal to the laser control circuit 123 in accordance with the playback instruction from the host. The laser control circuit 123 drives the laser 111 based on the playback control signal. In accordance with this operation, the laser 111 emits the playback light beam.

The playback light beam emitted from the laser 111 becomes parallel light by the collimator lens 112, and enters and passes through the PBS 113. The light beam passing through the PBS 113 then passes through the quarter wavelength plate 114, and focused on the information recording surface (e.g., groove track) of the optical disk D by the objective lens 115. The focused playback light beam is maintained in an optimal microspot on the recording surface by focus control performed by the focus control circuit 132 and actuator 126, and the tracking control performed by the tracking control circuit 134 and actuator 126. In this case, the playback light beam emitted on the optical disk D is reflected by the reflecting layer. Reflected light passes through the objective lens 115 in the opposite direction, and becomes the parallel light again. The reflected light then passes through the quarter wavelength plate 114, has vertical polarization with respect to incident light, and is reflected by the PBS 113. The beam reflected by the PBS 113 becomes convergent light by the focus lens 116, and enters the photodetector 117. The photodetector 117 has, e.g., four photodetectors. The light beam which becomes incident on the photodetector 117 is photoelectrically converted into an electrical signal and amplified. The amplified signal is equalized and binarized by the signal processing circuit 124 and sent to the demodulation circuit 125. The demodulation circuit 125 executes a demodulation operation corresponding to a predetermined modulation method and outputs playback data.

On the basis of part of the electrical signal output from the photodetector 117, the focus error signal generation circuit 131 generates a focus error signal. Similarly, on the basis of part of the electrical signal output from the photodetector 117, the tracking error signal generation circuit 133 generates a tracking error signal. The focus control circuit 132 controls the actuator 128 and the focus of the beam spot, on the basis of the focus error signal. The tracking control circuit 134 controls the actuator 128 and the tracking of the beam spot, on the basis of the tracking error signal.

The recording/playback operation will be described in detail. The demodulation circuit 125 in the optical disk apparatus reads out the polarity information from the optical disk (H-L recording layer). The recording/playback control unit 122 recognizes the polarity of each of the recording layers in the optical disk on the basis of the polarity information. For example, the recording/playback control unit 122 recognizes that the layer L0 is formed of the H-L recording layer (first recording layer), and the layer L1 is formed of the L-H recording layer (second recording layer). Hence, the recording/playback control unit 122 controls recording operation, records the information on the layer L0 before the layer L1 is used, and starts recording on the layer L1 after the recording area of the layer L0 is completely used. Also, the demodulation circuit 125 plays back the information recorded on the layer L0 on the basis of the fact that the information is recorded in accordance with the first reflectance characteristic in which the reflectance in the information recorded state is lower than that in the information unrecorded state. Similarly, the demodulation circuit 125 plays back the information recorded on the layer L1 on the basis of the fact that the information is recorded in accordance with the second reflectance characteristic in which the reflectance in the information recorded state is higher than that in the information unrecorded state.

Alternatively, for example, the recording/playback control unit 122 recognizes that the layer L1 is formed of the H-L recording layer (first recording layer), and the layer L0 is formed of the L-H recording layer (second recording layer). Hence, the recording/playback control unit 122 controls the recording operation, records the information on the layer L1 before the layer L0 is used, and starts recording on the layer L0 after the recording area of the layer L1 is completely used. Also, the demodulation circuit 125 plays back the information recorded on the layer L1 on the basis of the fact that the information is recorded in accordance with the first reflectance characteristic in which the reflectance in the information recorded state is lower than that in the information unrecorded state. Similarly, the demodulation circuit 125 plays back the information recorded on the layer L0 on the basis of the fact that the information is recorded in accordance with the second reflectance characteristic in which the reflectance in the information recorded state is higher than that in the information unrecorded state.

Note that if the polarity information cannot be read out or is not recorded, the signal processing circuit 124 identifies the H-L recording layer (first recording layer) from the L-H recording layer (second recording layer) by detecting the difference between the reflectances of the recording layers. For example, it is recognized that the layer L0 is formed of the H-L recording layer (first recording layer), and the layer L1 is formed of the L-H recording layer (second recording layer). Hence, as described above, the recording/playback control unit 122 controls the recording operation, records the information on the layer L0 before the layer L1 is used, and starts recording on the layer L1 after the recording area of the layer L0 is completely used. Also, as described above, the demodulation circuit 125 plays back the information recorded on the layers L0 and L1. Alternatively, for example, it is recognized that the layer L1 is formed of the H-L recording layer (first recording layer), and the layer L0 is formed of the L-H recording layer (second recording layer). Hence, as described above, the recording/playback control unit 122 controls the recording operation, records the information on the layer L1 before the layer L0 is used, and starts recording on the layer L0 after the recording area of the layer L1 is completely used. As described above, the demodulation circuit 125 plays back the information recorded on the layers L0 and L1.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disk including a first surface and a second surface, comprising:
a first recording layer which is arranged between the first surface and the second surface, and on which information is configured to be recorded by undergoing a change in properties when irradiated with a laser beam from the first surface; and
a second recording layer which is arranged between the first surface and the second surface, and on which the information is configured to be recorded by undergoing the change in the properties when irradiated with the laser beam from the first surface, wherein
the first recording layer has a first reflectance characteristic in which reflectance in an information recorded state is lower than reflectance in an information unrecorded state, and
the second recording layer has a second reflectance characteristic in which the reflectance in the information recorded state is higher than the reflectance in the information unrecorded state.

2. A disk according to claim 1, wherein
the first recording layer is arranged between the first surface and the second recording layer.

3. A disk according to claim 1, wherein
the second recording layer is arranged between the first surface and the first recording layer.

4. A disk according to claim 1, wherein
the first recording layer is used to record the information before the second recording layer is used, and
the second recording layer is used to record the information after a recording area of the first recording layer is completely used.

5. A disk according to claim 1, wherein
the first recording layer is a layer on which control information and management information are recorded.

6. A disk according to claim 1, wherein
the first recording layer is a layer on which polarity information indicating that the first recording layer has the first reflectance characteristic, and that the second recording layer has the second reflectance characteristic is recorded.

7. An information playback apparatus which plays back information recorded on an optical disk including a first surface and a second surface, comprising:
an emitting unit configured to emit a light beam on the optical disk having a first recording layer which is arranged between the first surface and the second surface, and on which information is configured to be recorded by a laser beam from the first surface, and a second recording layer which is arranged between the first surface and the second surface, and on which the information is configured to be recorded by the laser beam from the first surface, wherein the first recording layer has a first reflectance characteristic in which reflectance in an information recorded state is lower than reflectance in an information unrecorded state, and the second recording layer has a second reflectance characteristic in which the reflectance in the information recorded state is higher than the reflectance in the information unrecorded state,
a detection unit configured to detect reflected light from the optical disk, and
a playback unit configured to play back the information recorded on the optical disk, on the basis of the reflected light detected by the detection unit.

8. An apparatus according to claim 7, wherein
the playback unit plays back the information recorded on the first recording layer on the basis of a fact that the information is recorded in accordance with the first reflectance characteristic in which the reflectance in the information recorded state is lower than the reflectance in the information unrecorded state, and plays back the information recorded on the second recording layer on the basis of a fact that the information is recorded in accordance with the second reflectance characteristic in which the reflectance in the information recorded state is higher than the reflectance in the information unrecorded state.

9. An apparatus according to claim 7, wherein
the playback unit plays back the information recorded on the first recording layer in accordance with the first reflectance characteristic, and plays back the information recorded on the second recording layer in accordance with the second reflectance characteristic, on the basis of polarity information which is recorded on the first recording layer to indicate that the first recording layer has the first reflectance characteristic and that the second recording layer has the second reflectance characteristic.

10. An apparatus according to claim 7, wherein
the playback unit plays back the information recorded on the first recording layer in accordance with the first reflectance characteristic, and plays back the information recorded on the second recording layer in accordance with the second reflectance characteristic, on the basis of a difference between the reflectance of the first recording layer and the reflectance of the second recording layer, which are detected by the detection unit.
